(19) United States
(12) Patent Application Publication
(10) Pub. No.: US 2014/0130430 A1
(43) Pub. Date: May 15, 2014

(54) HARDWOOD STAIR TREAD OVERLAY

(71) Applicant: James M. McCool, Columbus, OH (US)

(72) Inventor: James M. McCool, Columbus, OH (US)

(21) Appl. No.: 14/156,404

(22) Filed: Jan. 15, 2014

Related U.S. Application Data
(62) Division of application No. 12/436,378, filed on May 6, 2009, now Pat. No. 8,640,404.
(60) Provisional application No. 61/050,636, filed on May 6, 2008.

(51) Int. Cl. E04F 11/16; B27M 1/08; B27M 3/12; E04F 11/108

(52) U.S. Cl. CPC E04F 11/16; E04F 11/108; B27M 1/08; B27M 3/12
USPC 52/179; 144/355; 144/346; 144/353

(57) ABSTRACT

A stair tread overlay and a riser overlay made from solid wood for fitting over a conventional, exposed wooden stair having a generally rounded nose like those found in most residential general construction staircases and prefabricated staircases. The tread overlay and riser overlay cover the exterior surface of a conventional wooden stair from stringer to stringer to hide a construction grade stair tread and riser below that are made from a composite material or unsalvageable hardwood to present an attractive, solid wood surface that is finishable.

### CROSS-REFERENCES TO RELATED APPLICATIONS

This application is a divisional of U.S. patent application Ser. No. 12/436,378 filed on May 6, 2009 entitled “Hardwood Stair Tread Overlay” which claims the benefit of U.S. Provisional Application No. 61/050,636 filed May 6, 2008, the entirety of both of which are incorporated herein.

### BACKGROUND OF THE INVENTION

1. Field of the Invention

This invention relates generally to the field of staircase repair and restoration and relates more particularly to hardwood overlays for covering an existing composite or solid wood staircase and a method of installing the same.

2. Description of the Related Art

Conventional staircases of the type found in many residential buildings are commonly fabricated from raw, construction grade materials, such as plywood, fiberboard or various other composites, and are covered with flooring materials such as carpeting to provide an attractive and comfortable exterior surface. It is also relatively common for residential staircases to be fabricated from solid hardwood, such as oak, walnut, or cherry. Hardwood staircases are generally more desirable than carpeted composite staircases and are more expensive to construct due to the higher cost of the materials involved.

In the case of carpeted staircases, it is sometimes desirable to upgrade the staircase to a solid hardwood staircase for aesthetic reasons, such as when the seller of a home wishes to make the home more attractive to potential buyers, even when the original carpeted staircase is in good condition. In the case of hardwood staircases, the accumulation of surface wear over the course of time can make replacement of the staircase desirable, and sometimes even necessary, for aesthetic and functional reasons. In either case, replacing an existing staircase with a new, solid hardwood staircase typically requires extensive demolition and can sometimes be prohibitively expensive.

It would therefore be advantageous to have a means for achieving the appearance, durability, and longevity of a brand new, solid hardwood staircase without having to demolish an existing hardwood or carpeted composite staircase. It would further be advantageous to have such a means that is affordable and that can be implemented quickly and easily.

### BRIEF SUMMARY OF THE INVENTION

In accordance with the present invention, there is provided a stair tread overlay and a riser overlay that are made from solid wood and that are milled and cut to fit over a conventional, exposed wooden stair having a generally rounded nose like those found in most residential general construction staircases and prefabricated staircases. The tread overlay and riser overlay can cover a conventional wooden stair tread and riser completely from end to end (stringer to stringer) to hide a construction grade stair tread and riser (e.g., a stair tread and a riser that are made from plywood or another composite and that are typically covered with flooring material, such as carpeting) or an unsalvageable hardwood stair tread and riser to present an attractive, solid wood surface that is finishable. The tread overlay and riser overlay can also be used to cover a tread and riser only at the longitudinal ends of the tread and riser, against the abutting stringers of the staircase, to provide a finished hardwood surface at each end of the tread and riser in order to facilitate the installation of a carpet type runner in the middle of the staircase.

The profile of the tread overlay is preferably J-shaped and conforms to the shape of a conventional wooden stair tread profile having a rounded front edge. The overlay is formed with a length and a depth that are greater than that of a standard tread for allowing the overlay to be trimmed to size for accommodating a variety of standard and non-standard applications. The overlay can be milled and/or carved to allow fitment over multiple tread thicknesses. The overlay is affixed to an existing tread by using any conventional wood-to-wood adhesive, although it is contemplated that any other fastener for mounting the overlay to an existing tread, such as nails or screws, can also be used.

The tread overlay and riser overlay are preferably each formed of a single piece of solid hardwood material with an exterior surface that is finishable for accepting a desired stain color and/or finish coat. It is contemplated, however, that the overlay can be formed of multiple pieces of wood that are fit together. The overlays can be finished prior to installation (prefinished) or finished after installation (site finished).

The invention thus provides an alternative means of converting wooden staircases made from construction grade materials (solid or composite) or unsalvageable hardwood staircases into substantially new-looking solid hardwood staircases. The invention simplifies the task of conversion by eliminating the need to demolish, modify, and/or reconstruct the existing staircase as is typical with current methods for achieving hardwood conversion. Applying the tread overlays and riser overlays of the present invention to an existing staircase provides the staircase with an exterior surface that is consistent with most characteristics of a conventional solid hardwood staircase. The overlays achieve the beauty, durability and longevity that solid wood provides. Because the overlays are made of solid hardwood and have a substantial thickness, they are sandable and refinishable.

### BRIEF DESCRIPTION OF THE SEVERAL VIEWS OF THE DRAWINGS

FIG. 1 is a perspective exploded view in section illustrating the preferred embodiment of the present invention.

FIG. 2 is a side view illustrating the tread overlay of the preferred embodiment of the present invention shown in FIG. 1.

FIG. 3 is a side view in section illustrating the preferred embodiment of the present invention.

FIG. 4 is a perspective view illustrating a first alternative embodiment of the present invention.

FIG. 5 is a perspective exploded view in section illustrating a second alternative embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

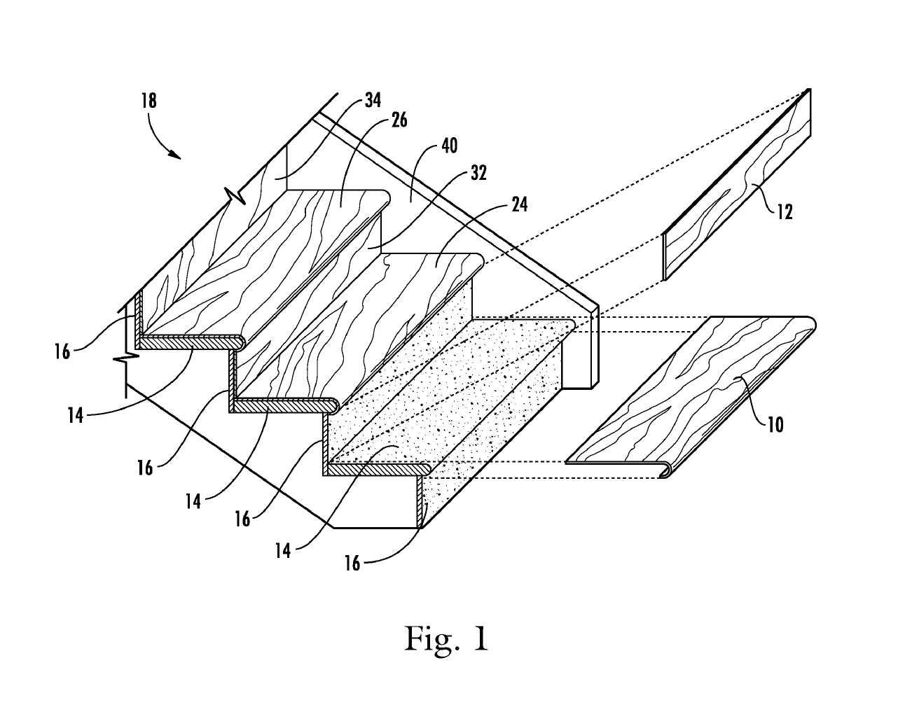

Referring to FIGS. 1-3, a stair tread overlay 10 and a riser overlay 12 for fitting over the treads 14 and risers 16 of a prefabricated composite or solid wood staircase 18 are shown. Both the tread overlay 10 and the riser overlay 12 are fabricated from solid oak, although it is contemplated that the tread overlay 10 and the riser overlay 12 can alternatively be fabricated from the wood of any non-monocot angiosperm tree (i.e., hardwood), including, but not limited to walnut, ash, cherry, and hickory. It is further contemplated that the tread overlay 10 and riser overlay 12 can be fabricated from the wood of any coniferous tree (i.e., softwood), including, but not limited to cedar, pine, and spruce, although hardwoods are generally preferred over softwoods for their superior durability.

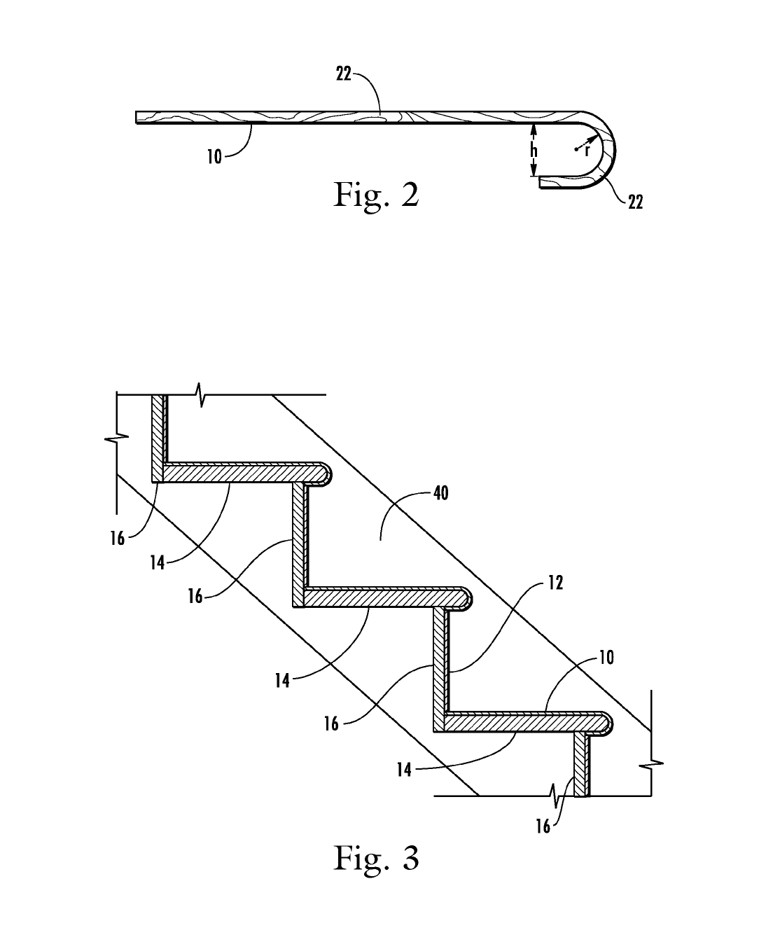

The tread overlay 10 is preferably milled from a solid piece of hardwood and is defined by a planar tread portion 20 (see FIG. 2) and a rounded nose portion 22, although it is contemplated that the tread overlay 10 can be formed of two or more separate pieces of wood that are mounted to one another, such as with conventional fasteners or adhesives. For example, an equivalent tread overlay can be made of a separate planar panel and a curved piece that are glued together when installed. Referring to FIG. 2, the tread overlay has a J-shaped profile with a uniform thickness of ⅜ inches, although it is contemplated that tread overlay 10 can have any thickness in a range of about 0.05 inches to about 1 inch. It is further contemplated that the thickness of the tread overlay 10 can be non-uniform, for example to accommodate an underlying obstruction.

The nose portion 22 of the tread overlay has an interior height, h of 1.5 inches and an interior radius, r of 0.75 inches for fitting over the nosing of most standard size stair treads (as will be described in greater detail below), although it is contemplated that the interior height, h and interior radius, r of the tread overlay 10 can be varied to conform to the size and shape of any stair tread that is to be covered. It is further contemplated that the nose portion 22 of the tread overlay can have a variety of other profile shapes, such as rectangular or triangular, for conforming to an existing stair tread that is not rounded. Still further, it is contemplated that the nose portion 22 of the tread overlay can have an interior profile shape that conforms to the nose shape of a stair tread to be covered but an exterior profile shape that is different than the nose shape of the stair tread to be covered. For example, it is contemplated that the nose portion 22 of the tread overlay 10 can have a rounded interior profile shape for fitting over the rounded nose of an underlying stair tread and a square exterior profile shape for providing the underlying staircase with a new and different exterior shape. Still further, it is contemplated that voids can exist if the interior profile shape does not precisely conform to the exterior shape of the stair tread.

Referring to FIG. 1, the tread overlay 10 and a plurality of similar tread overlays 24 and 26 that are intended to cover the stair treads 14 of the same existing composite or unsalvageable solid wood staircase 18 are preferably fabricated with a uniform width and a uniform depth that are greater than the width and the depth of the stair treads 14 that are to be covered. The tread overlays 10, 24, and 26 can therefore be individually trimmed down to a necessary width and depth on-site, such as with a table saw or a circular saw. This allows precise custom fitting of the tread overlays 10, 24, and 26 for each of the individual stair treads 14 in the existing staircase 18, some of which may have been built with intended or unintended variances in size or which may have shifted or been repaired over time. For example, for covering most standard size stair treads having a width of 3.5 feet and a depth of 10 inches, the tread overlays 10, 24, and 26 are preferably fabricated with a width of 4 feet and a depth of 12 inches. Alternatively, it is contemplated that the treads 14 on the existing staircase 18 can be individually measured and that each individual tread overlay 10, 24, and 26 can be fabricated with dimensions matching a specific premeasured tread 14 to achieve a proper fit thereon.

Still referring to FIG. 1, the riser overlay 12 is an elongated rectangular panel that is preferably cut from a single piece of hardwood, although it is contemplated that the riser overlay 12 can be formed of two or more separate pieces of wood that are mounted to one another, such as with conventional fasteners or adhesives. The riser overlay 12 has a uniform thickness of ⅜ inches, although it is contemplated that riser overlay 12 can have any thickness in a range of about 0.05 inches to about 1 inch. It is further contemplated that the thickness of the riser overlay 12 can be non-uniform. Still further, it is contemplated that the riser overlay 12 can have any shape other than rectangular, such as triangular or trapezoidal, for conforming to the shape of a particular riser that is to be covered.

As with the stair tread overlays 10, 24, and 26 described above, the riser overlay 10 and a plurality of similar riser overlays 32 and 34 that are intended to cover the risers 16 of the same existing staircase 18 are preferably fabricated with a uniform width and a uniform height that are greater than the width and the height of the risers 16 that are to be covered. The riser overlays 12, 32, and 34 can therefore be individually trimmed to a necessary width and height on-site, such as with a table saw or a circular saw, to allow precise custom fitting of the riser overlays 12, 32, and 34 for each of the individual risers 16 in the existing staircase 18, some of which may have been built with intended or unintended variances in size. For example, for covering most standard size stair risers having a width of 3.5 feet and a height of 7 inches, the riser overlays 12, 32, and 34 are preferably fabricated with a width of 4 feet and a height of 8 inches. Alternatively, it is contemplated that the risers 16 on the existing staircase 18 can be individually measured and that each individual riser overlay 12, 32, and 34 can be fabricated with dimensions matching a specific premeasured riser 16 to achieve a proper fit thereon.

In order to install the tread overlays 10, 24, and 26 and the riser overlays 12, 32, and 34 on an existing composite or unsalvageable hardwood staircase, such as the staircase 18 in FIG. 1, an installer first measures the width and depth of the existing staircase's treads 14 and the width and height of the existing staircase's risers 16. If the existing treads 14 and risers 16 are obviously of uniform size, the installer will generally only need to measure the tread and riser of a single stair, otherwise the installer will have to measure each tread and riser that differs in size.

Next, the tread overlays 10, 24, and 26 and the riser overlays 12, 32, and 34 of the present invention, which are fabricated with dimensions larger than those of the existing treads 14 and risers 16 (as described above), are cut down to the measured sizes of the existing treads 14 and risers 16 on-site. For example, the tread overlays 10, 24, and 26 are cut longitudinally and laterally to reduce their depths and widths, respectively, to appropriate sizes. Similarly, the riser overlays 12, 32, and 34 are cut laterally to reduce their widths to appropriate sizes.

Finally, the cut tread overlays 10, 24, and 26 and cut riser overlays 12, 32, and 34 are firmly mounted to the treads 14 and risers 16 of the existing staircase with conventional wood-to-wood adhesive. Of course, it is contemplated that the tread overlays 10, 24, and 26 and riser overlays 12, 32, and 34 can be mounted to the treads 14 and risers 16 using any other suitable means of affixation, such as with conventional fasteners or with other types of adhesives. The surfaces of the tread overlays 10, 24, and 26 and riser overlays 12, 32, and 34 that face and engage the existing treads 14 and risers 16 have a moderately rough texture for holding the adhesive to achieve proper adhesion. Such a surface texture can be achieved using any conventional means, such as by sanding or by the milling and cutting processes used to fabricate the overlays 10, 24, 26, 12, 32, and 34. In some cases, it may be beneficial or necessary to sand or otherwise distress the exterior surfaces of the existing stair treads 14 and risers 16 before mounting the overlays 10, 24, 26, 12, 32, and 34 in order to provide the treads 14 and risers 16 with a surface that is sufficiently rough to hold the adhesive.

Once installed, the tread overlays 10, 24, and 26 and riser overlays 12, 32, and 34 cover substantially all of the exterior surfaces of the treads 14 and risers 16 of the underlying staircase from stringer 41 to the other stringer (only the stringer 41 is shown in FIGS. 1 and 3). The tread overlays 10, 24, and 26 and riser overlays 12, 32, and 34 preferably have finishable exterior surfaces for accepting any desired stain color and/or finish coat, such as varnish or paint. It is contemplated that the overlays 10, 24, 26, 12, 32, and 34 can be finished prior to installation (prefinished) or finished after installation (site finished) as will be appreciated by those skilled in the art of flooring materials.

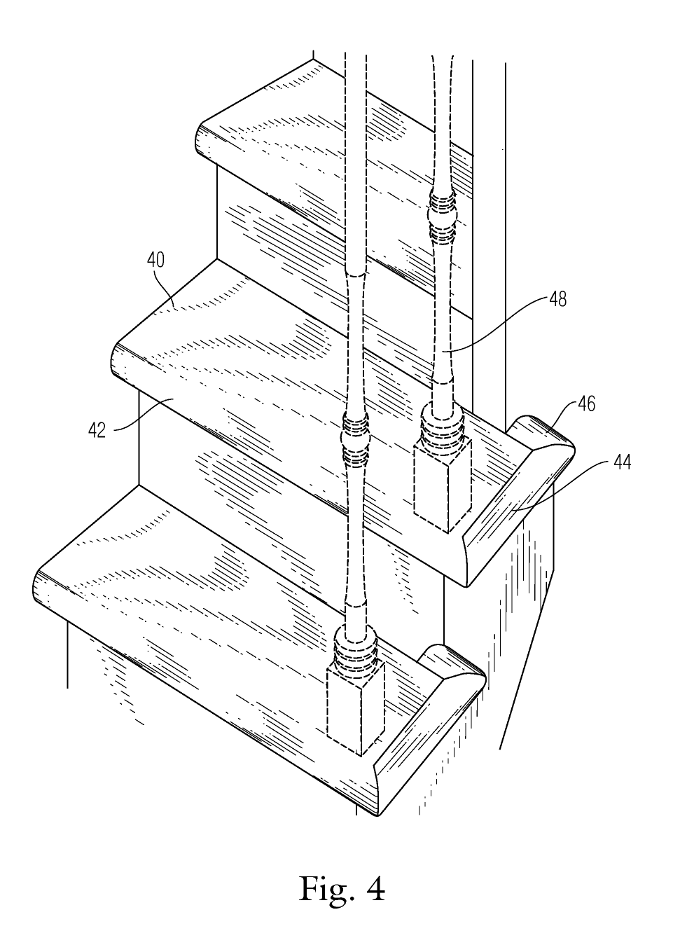

Referring to FIG. 4, a first alternative embodiment of the inventive tread overlay, indicated generally at 40, is contemplated for fitting over an “open-ended” stair tread. An “open-ended” stair tread is defined herein as a stair tread having a first longitudinal end that abuts a conventional stringer and an opposite longitudinal end that extends into open space (i.e., does not abut a stringer in the same way). An open-ended tread therefore has three exposed edges (i.e., a front edge, a partially protruding rear edge, and a longitudinal edge) which is to be contrasted with the “closed-end” stair treads 14 described above which only have one exposed edge (i.e., a front edge).

The tread overlay 40 is similar to the tread overlay 10 described above with a first nose portion 42 extending from the front of the tread portion, but additionally includes a second, separate nose portion 44 adjoining the first nose portion 42 that extends from a longitudinal end of the tread portion and a third, separate nose portion 46 adjoining the second nose portion 44 that extends from the rear of the tread portion. When assembled together, the three nose portions 42, 44, and 46 cover all three exposed edges of the underlying open-ended tread. It is contemplated that the tread overlay 40 can alternatively be fabricated with a fourth adjoining nose portion (not pictured) extending from the opposite longitudinal end of the tread overlay 40 from the second nose portion 44 for covering a stair tread having two open longitudinal ends (i.e., a tread that does not abut a stringer at either longitudinal end). During installation, the tread overlay 40 is measured, cut, and mounted in a substantially similar manner to the tread overlay 10 described above. It should be noted that some open-ended staircases feature a banister, such as the banister 48, which generally must be removed before the overlay 40 is installed and can be replaced after installation is complete. Once the overlay 40 is installed, the nose portions 44 and 46 are trimmed and installed.

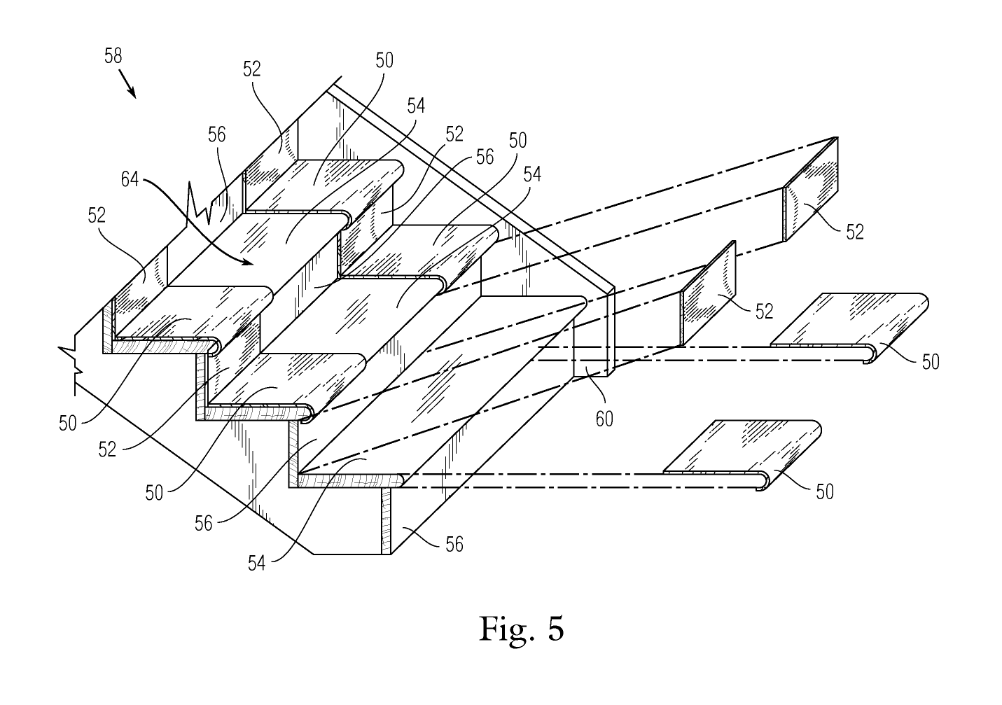

Referring to FIG. 5, a second alternative embodiment of the present invention is contemplated for accommodating the installation of a central runner made from a flooring material such as carpeting or tile on a staircase. In this embodiment, the tread overlays 50 and riser overlays 52 are similar to the tread overlay 10 and riser overlay 12 described above, except that each of the tread overlays 50 and riser overlays 52 has a width that is less than half the width of the stair treads 54 and risers 56 of the underlying staircase 58. The tread overlays 50 and riser overlays 52 are mounted over the opposing longitudinal ends of their respective stairs in abutment with the stringer 60 and the opposite stringer (only the stringer 60 is shown in FIG. 5). Each pair of tread overlays 50 and each pair of riser overlays 52 thus define an exposed central channel 64 in which flooring material, such as carpeting or tile, can be installed in a conventional manner in direct contact with the existing staircase 58 to provide the staircase 58 with a central runner. The flooring material of the runner thereby sits flush with the longitudinally-adjacent tread overlays 50 and riser overlays 52 and presents an attractive, uniform appearance.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A stair tread overlay for fitting over a stair tread comprising: a rigid overlay manufactured in a J-shape having a tread portion for fitting over a top planar portion of the stair tread and a non-planar nose portion extending from an edge of the top tread portion for fitting over the nose of the stair tread wherein the non-planar nose portion has a curved inner surface.

2. The tread overlay in accordance with claim 1 wherein the nose portion of the tread overlay has a curved outer surface.

3. The tread overlay in accordance with claim 1 wherein the rigid overlay is a wood based single piece.

4. The tread overlay in accordance with claim 1 wherein at least one surface of the overlay is treated to provide a finished wood grain appearance.

5. A stair tread overlay comprising: a rigid overlay manufactured in a J-shape having a tread portion, a non-planar nose portion, and an exterior surface, wherein the non-planar nose portion has a preformed concave inner surface and at least one surface of the overlay has a wood grain appearance.

6. The tread overlay in accordance with claim 5, wherein the rigid overlay is an engineered single piece adhesive and wood based unit.

7. A stair tread overlay comprising: a single piece adhesive and wood based rigid overlay manufactured in a J-shape having a tread portion and a non-planar nose portion, wherein the non-planar nose portion has a preformed concave inner surface.

8. A method of manufacturing a stair tread overlay comprising the steps of:
forming a solid piece of wood material into a planar tread portion;
forming a solid piece of material into a nose portion having an inner surface, wherein the inner surface has an interior height and an interior radius which forms an inner concave surface; and
connecting the planar tread portion to the rounded nose portion to form a J shaped tread overlay.

9. The method of claim 8, further including the step of connecting the planar tread portion to the rounded nose portion using adhesive.

10. The method of claim 8, further including the step of connecting the planar tread portion to the rounded nose portion using fasteners.

11. The method of claim 8, further including the step of forming a rough texture on the bottom surface of the planar tread portion.

12. The method of claim 11, wherein the rough texture on the bottom surface of the planar tread portion is formed by milling.

13. The method of claim 11, wherein the rough texture on the bottom surface of the planar tread portion is formed by sanding.

14. The method of claim 11, wherein the rough texture on the bottom surface of the planar tread portion is formed by cutting.

15. The method of claim 8, wherein the interior radius is approximately 0.75 inches.

16. The method of claim 8, wherein the inner height is approximately 1.5 inches.
